(19) United States
(12) Patent Application Publication
(10) Pub. No.: US 2025/0206663 A1
(43) Pub. Date: Jun. 26, 2025

(54) ENGINEERED STONE

(71) Applicant: QUEEN CERAMIC INCORPORATION, Taipei City (TW)

(72) Inventors: Cheng-Hsuan LAI, Taipei City (TW); Wei-Min CHEN, Taipei City (TW); Lei LIN, Taipei City (TW)

(21) Appl. No.: 19/053,390

(22) Filed: Feb. 13, 2025

Related U.S. Application Data
(63) Continuation-in-part of application No. 18/585,022, filed on Feb. 22, 2024, now Pat. No. 12,252,448.

(30) Foreign Application Priority Data
Dec. 25, 2023 (TW) 112150632

(51) Int. Cl. C04B 14/06; C04B 14/30; C04B 18/167; C04B 103/54

(52) U.S. Cl. CPC C04B 14/06; C04B 14/303; C04B 18/167; C04B 2103/54

(57) ABSTRACT

In the present disclosure, an engineered stone is provided. The engineered stone includes a first full-body stone pattern, a second full-body stone pattern, a third full-body stone pattern, and a printed stone pattern. The first full-body stone pattern includes a first stone formulation. The second full-body stone pattern includes a second stone formulation, and the second stone formulation is different from the first stone formulation, wherein the first full-body stone pattern and the second full-body stone pattern are located on a front surface, a plurality of side surfaces and a back surface opposite to the front surface of the engineered stone. The printed stone pattern is located on the front surface of the engineered stone, and the printed stone pattern is overlapped with the first full-body stone pattern and the second full-body stone pattern.

### CROSS-REFERENCE TO RELATED APPLICATION

This application is a Continuation-in-part of U.S. application Ser. No. 18/585,022, filed on Feb. 22, 2024, which claims priority to Taiwan Application Serial Number 112150632, filed Dec. 25, 2023, which is herein incorporated by reference in its entirety.

### BACKGROUND

### Field of Invention

The present disclosure relates to an engineered stone. More particularly, the present disclosure relates to a stone pattern printing method for the engineered stone.

### Description of Related Art

With the rise of environmental awareness, in order to reduce the mining of natural stones, people began to develop engineered stone slabs that imitating natural stone slabs. In order to produce realistic engineered stone slabs, the manufacturing process of engineered stone slabs has become more complicated, which often leads to errors in the vein pattern of the stone slabs due to different operators.

Accordingly, the present disclosure provides a method that may produce realistic engineered stone slabs stably and simply.

### SUMMARY

In accordance with an aspect of the present disclosure, an engineered stone is provided. The engineered stone includes a first full-body stone pattern, a second full-body stone pattern, a third full-body stone pattern and a printed stone pattern. The first full-body stone pattern includes a first stone formulation. The second full-body stone pattern includes a second stone formulation, and the second stone formulation is different from the first stone formulation, wherein the first full-body stone pattern and the second full-body stone pattern are located on a front surface, a plurality of side surfaces and a back surface opposite to the front surface of the engineered stone. The third full-body stone pattern comprising a third stone formulation, and the third stone formulation is different from the first stone formulation and the second stone formulation, wherein the third full-body stone pattern located on the front surface of the engineered stone and does not extend completely from the front surface to the back surface. The printed stone pattern is located on the front surface of the engineered stone, and the printed stone pattern is overlapped with the first full-body stone pattern and the second full-body stone pattern, and the third full-body stone pattern.

According to some embodiments of the present disclosure, wherein the first stone formulation the second stone formulation, and the third stone formulation include recycling building material, aluminum hydroxide, quartz powder, resin and pigment.

According to some embodiments of the present disclosure, wherein the recycling material includes recycled building material, recycled photovoltaic material, recycled glass, and combinations thereof.

According to some embodiments of the present disclosure, wherein a first color of the first full-body stone pattern is different from a second color of the second full-body stone pattern.

According to some embodiments of the present disclosure, wherein a third color of the third full-body stone pattern is different from the first color of the first full-body stone pattern and the second color of the second full-body stone pattern.

According to some embodiments of the present disclosure, wherein the first full-body stone pattern extends from the front surface to the back surface of the engineered stone.

According to some embodiments of the present disclosure, wherein the second full-body stone pattern extends from the front surface to the back surface of the engineered stone.

According to some embodiments of the present disclosure, wherein a penetration depth of the printed stone pattern on the front surface of the engineered stone is 1 to 5 millimeter (mm).

According to some embodiments of the present disclosure, wherein a thickness of the engineered stone is between 15 mm to 30 mm.

According to some embodiments of the present disclosure, wherein the third full-body stone pattern is located on the front surface and one of the plurality of side surfaces of the engineered stone.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a flowchart of a color mapping method for designing the stone pattern, in accordance with some embodiments;

FIG. 2 is a flowchart of a method for manufacturing a full-body stone slab, in accordance with some embodiments;

FIG. 3 is a flowchart of a positioning printing method, in accordance with some embodiments;

FIG. 4 is a schematic diagram of a vein pattern, in accordance with some embodiments;

FIG. 5 is a schematic diagram of printing the vein pattern of FIG. 4 on a front surface of the engineered stone, in accordance with some embodiments; and

FIG. 6 is a schematic diagram of an engineered stone, in accordance with some embodiments.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Although a series of operations or steps are used to illustrate the method of the present disclosure, the order shown in these operations or steps should not be construed as a limitation of the disclosure. For example, certain operations or steps may be performed in a different order and/or concurrently with other steps. Furthermore, not all illustrated operations, steps, and/or features must be performed to implement embodiments of the present disclosure, and each operation or step described herein may include several sub-steps or actions.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

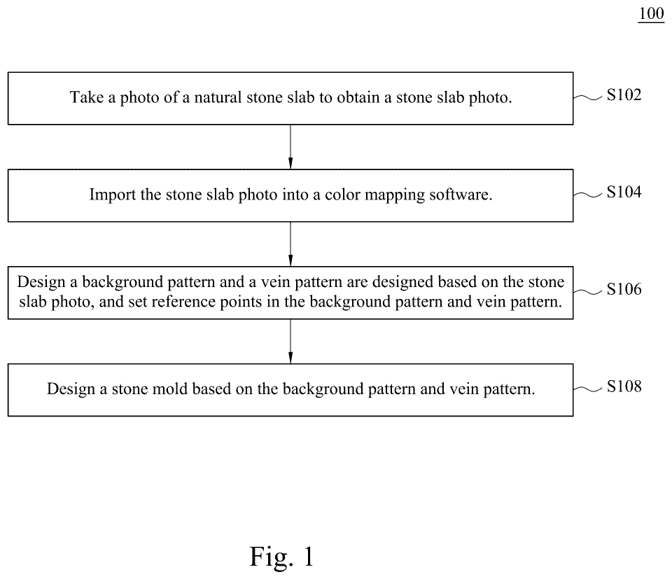

The present disclosure provides a method for manufacturing engineered stone. FIG. 1 is a flowchart of a color mapping method 100 for designing the stone pattern, in accordance with some embodiments. In step S102, first, a photo of a natural stone slab is taken to obtain a stone slab photo. In some embodiments, the natural stone slab is photographed under a uniform light source with a color calibration plate placed nearby. In some embodiments, the natural stone slab can be a quartz slab, a marble slab, a granite slab, etc., and a suitable natural stone slab can be selected according to actual design requirements.

In step S104, the stone slab photo is imported into a color mapping software. Then, the stone slab photo is compared with pre-imported templates in color mapping software. In some embodiments, multiple stone slab photos can be obtained and compared multiple times in color mapping software to obtain accurate RGB values of the background color and vein pattern of the natural stone slab.

In step S106, in the color mapping software, a background pattern and a vein pattern are designed based on the stone slab photo(s), and reference points are set in the background pattern and vein pattern. The background pattern is the basic background color of the stone slab, and the vein pattern is the detailed texture being printed on the engineered stone, which will be described in detail later. In some embodiments, three reference points are set. In other embodiments, more than three reference points may be set. The reference points can be set at a position that will not change in subsequent processes, such as the intersection of background pattern and/or the intersection of vein pattern.

In step S108, a stone mold is designed based on the background pattern and the vein pattern, wherein corresponding mold reference points are set in the stone mold according to the reference points. In some embodiments, after designing the stone mold, the stone mold can be produced through laser cutting, computer numerical control (CNC) machine tool or 3D printing.

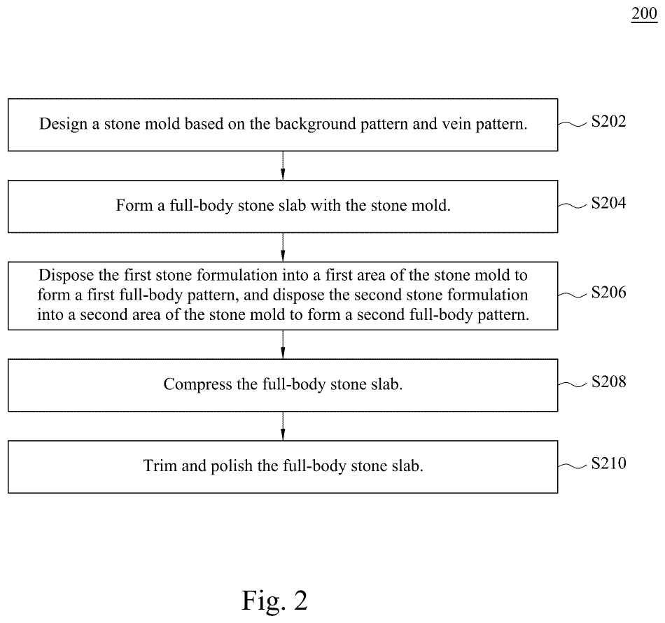

FIG. 2 is a flowchart of a method 200 for manufacturing a full-body stone slab, in accordance with some embodiments. In step S202, first, a first stone formulation and a second stone formulation are prepared based on the background pattern.

In some embodiments, the first stone formulation and the second stone formulation includes quartz powder unsaturated polyester resin, coupling agent, curing agent, dispersing agent, and pigment. For example, the first slab formulation and the second slab formulation include 25-35% by weight of quartz powder with an average particle size of 0.2-0.4 millimeters (mm), and 30-40% by weight of quartz powder with an average particle size of 0.1-0.2 mm, 20-30% by weight of quartz powder with an average particle size of 0.045 mm, 5.5-15.5% by weight of unsaturated polyester resin, 0.05-0.22% by weight of coupling agent, 0.07-0.18% by weight of dispersing agent, and 0.2-0.8 by weight of pigment.

In some embodiments, the first stone formulation and the second stone formulation can be environmentally friendly formulation. The first stone formulation and the second stone formulation include recycling material, aluminum hydroxide, quartz powder, unsaturated polyester resin, coupling agent, dispersing agent, and pigment. For example, the first slab formulation and the second slab formulation include 20-70% by weight of recycling material with an average particle size of 0.1-0.6 mm, 10-30% by weight of aluminum hydroxide with an average particle size of 0.012-0.018 mm, 20-35% by weight of quartz powder with an average particle size of 0.2-0.4 mm, 15-30% by weight of quartz powder with an average particle size of 0.1-0.2 mm, 10-25% by weight of quartz powder with an average particle size of 0.045 mm, 5.5-15.5% by weight of unsaturated polyester resin, 0.05-0.22% by weight of coupling agent, 0.5-2% by weight of dispersing agent, and 0.2-0.8 by weight of pigment.

In some embodiments, the recycling material includes recycled building material, recycled photovoltaic material, recycled glass, and combinations thereof. The recycled glass may be sourced from any appropriate discarded glass product. For example, the recycled glass can be recycled glass bottles, recycled window glass, recycled tempered glass, recycled heat-resistant glass, or vehicle glass. To give recycled electronic waste a new life, the recycled photovoltaic material may be sourced from photovoltaic modules, thin film transistor liquid crystal display (TFT-LCD) panel, semiconductor glass substrates. In photovoltaic modules/panel recycling process, after disassembling an aluminum frame, copper cable, and junction box, the inner portion is obtained. Then, a shredder method is used to delaminate the glass layer from the solar cell, followed by mechanical treatment. At this stage, glass was distributed in particle sizes from 7 mm to 25 mm. Then, two-blade motor crushing and hammer crushing can further downsize the glass to particle sizes from 2 mm to 8 mm. Combine ball mill and vibrating sieve to refine and collect different particle sizes of glass cullet. For example, the particle sizes of glass cullet from the recycled photovoltaic modules/panel can be 0.3-0.9 mm, 0.1-0.2 mm, 0.035-0.061 mm, 0.013-0.028 mm, 0.003-0.011 mm.

The method of preparing the first stone formulation includes the following steps. First, the resin material is prepared by putting the unsaturated polyester resin, coupling agent, dispersant, and curing agent into the dispersion tank and stirring evenly. Next, the coloring material is prepared by putting the unsaturated polyester resin and dispersing agent into another dispersion tank, stirring evenly and then slowly adding the pigment. Then, the quartz powder of each particle size is put into another dispersion tank in advance and is stirred evenly. Then, the resin material and coloring material are added and stirred evenly. Next, repeat the above steps to prepare the second stone formulation.

In some embodiments, the pigment of the first stone formulation and the second slab formulation are different. For example, the first stone formulation is green and the second slab formulation is light yellow. In some embodiments, the first stone formulation and the second slab formulation have different proportions of quartz powder in each particle size.

In some embodiments, the full-body stone slab can include more kinds of stone formulations. For example, the full-body stone slab includes four different color stone formulations to produce a full-body stone slab with more complex pattern.

In step S204, a full-body stone slab is formed with the stone mold, wherein alignment marks are made on a front surface of the full-body stone slab, and the alignment marks corresponding to the mold reference points of the stone mold. In some embodiments, the front surface of the full-body stone slab may be 3200 mm by 1600 mm. In other words, the length and/or width of the full-body stone slab can be between 1600 mm and 3200 mm. In some embodiments, the thickness of the full-body stone slab may be between 15 mm and 30 mm.

In step S206, the first stone formulation is disposed into a first area of the stone mold to form a first full-body stone pattern, and the second stone formulation is disposed into a second area of the stone mold to form a second full-body stone pattern. The first full-body stone pattern and the second full-body stone pattern extend from the front surface to the back surface of the full-body stone slab. In other words, the first full-body stone pattern and the second full-body stone pattern are not only located on the front and back of the full-body stone slab, but also on the side surfaces of the full-body stone slab. In other embodiments, the method includes forming a third full-body stone pattern, wherein the third full-body stone pattern is located on the front surface and one of the side surfaces of the full-body stone slab, or on the back surface and the side surfaces of the full-body stone slab. That is, it is also possible to form a pattern that does not completely extend from the front surface to the back surface, for example, the pattern extends on at least one surface of the stone slab.

Prior to perform step S208, separate the stone mold and the full-body stone slab. In step S208, the full-body stone slab is compressed. For example, the full-body stone slab is placed in a vibro-compaction machine and is compressed for 10-15 minutes. Then the full-body stone slab is placed in a curing device and at a temperature between 70 and 120° C. for 70 to 140 minutes.

Subsequent to the full-body stone slab is formed, in step S210, a polish process is performed to polish the surface of the full-body stone slab. In some embodiments, the front surface of the full-body stone slab is polished. In other embodiments, the front surface, back surface and side surfaces of the full-body stone slab are polished.

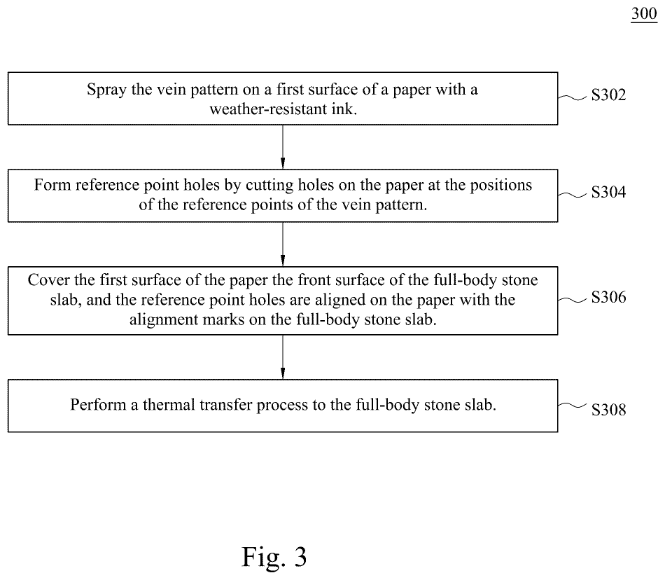

FIG. 3 is a flowchart of a positioning printing method 300, in accordance with some embodiments. In step S302, the vein pattern is sprayed on a first surface of a paper with a weather-resistant ink. In some embodiments, a roll-to-roll digital inkjet printer is used, with a printhead resolution of 720 dpi/2 rows. In some embodiments, the weather-resistant ink includes deionized water, propylene glycol, glycerin, resin, pigments, and additives. For example, the weather-resistant ink includes 55-65% by weight of deionized water, 8-12% by weight of propylene glycol, 12-15% by weight of glycerin, 10-20% by weight of dispersing dye, 10-20% by weight of wetting and dispersing agent, 0.2-1.5% by weight of UV absorber. In some embodiments, the weather-resistant inkjet may include 0.5-2% by weight of hindered amine light stabilizer, 0.02-0.4% by weight of bactericide, and/or 0.4-0.8% by weight of pH adjuster. The hindered amine light stabilizer may make disperse dyes less susceptible to discoloration or fading. The formula of the above-mentioned weather-resistant inkjet can stably discharge ink from the nozzle without settling, so there will be no color bleeding when sprayed on the drawing.

In step S304, holes are cut on the paper at the positions of reference points of the vein pattern to form reference point holes. In step S306, the first surface of the paper is covered on the front surface of the full-body stone slab, and the reference point holes are aligned on the paper with the alignment marks on the full-body stone slab, respectively. By aligning the reference point holes with the alignment marks of the full-body stone slab, the vein pattern can be smoothly aligned to the preset position to improve the accuracy of the printed pattern and create an engineered stone with exquisite and realistic vein pattern.

In step S308, a thermal transfer process is performed on the full-body stone slab to transfer the texture pattern to the front surface of the full-body stone slab. In some embodiments, the aligned paper and the full-body stone slab are placed into a heat press device the temperature is set between 140 and 200° C., and left for 15 to 30 minutes. In some embodiments, subsequent to the thermal transfer process, a cooling process is performed to cool the full-body stone slab for a period of time.

In some embodiments, subsequent to the thermal transfer process, the weather-resistant ink penetrates to a depth of about 1 to 5 mm on the front side of the solid stone slab. The wetting and dispersing agent in the weather-resistant ink in the present disclosure has a segmented polymer with a high degree of structural regularity, and has both alkaline and acidophilic dual-affinity polar functional groups. The amphiphilic polar functional groups in the wetting and dispersing agent coat the dye molecules and combine with the resin materials and quartz materials in the engineered stone through electrostatic force and dipole force, so that the dye can be stably fixed in the engineered stone.

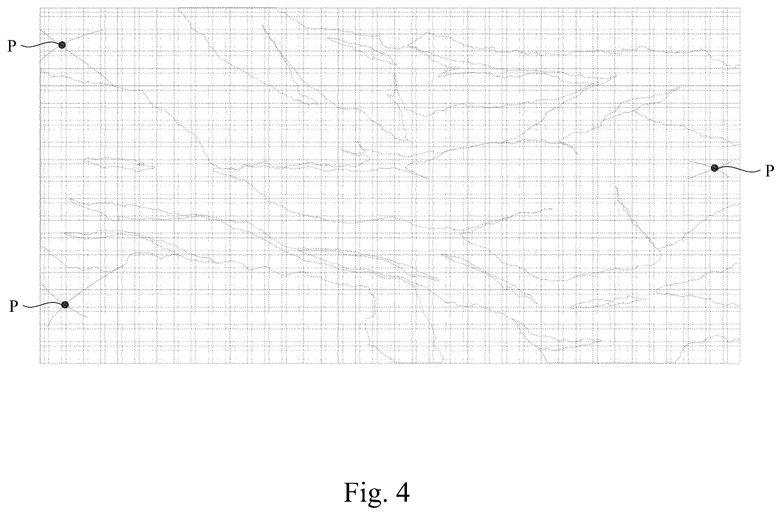

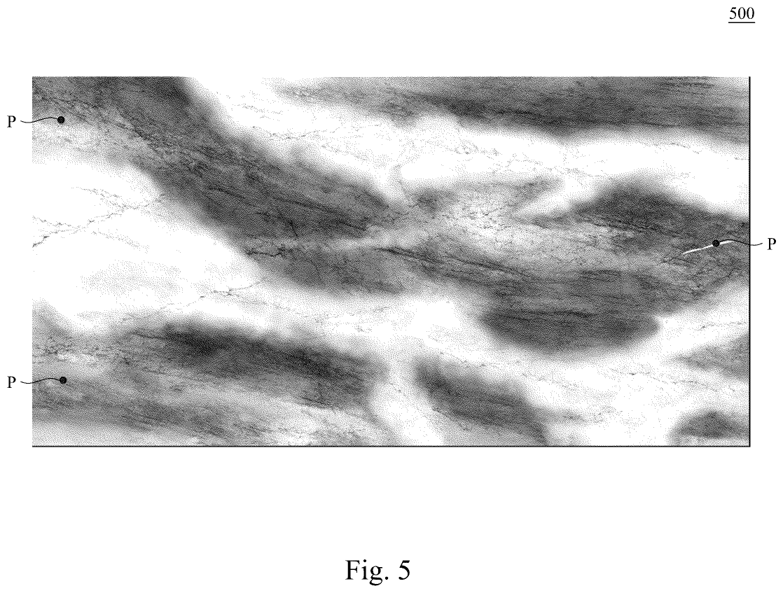

FIG. 4 is a schematic diagram of a vein pattern 400, in accordance with some embodiments. FIG. 4 shows that three reference points P are set in the vein pattern 400. However, in other embodiments, more than three reference points P may also be set. As shown, the reference point P is set at a position that may not change relatively in subsequent processes. In FIG. 4, the reference point P is set at the intersection of the pattern. FIG. 5 is a schematic diagram of printing the vein pattern 400 of FIG. 4 on a front surface 500 of the engineered stone, in accordance with some embodiments. The position of the corresponding reference points P are also shown in FIG. 5.

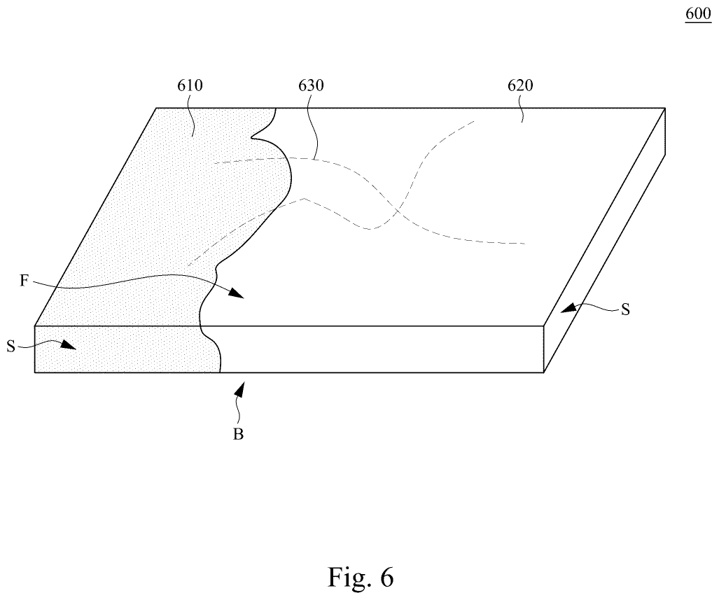

FIG. 6 is a three dimensional schematic diagram of an engineered stone 600, in accordance with some embodiments. The engineered stone 600 includes a first full-body stone pattern 610, a second full-body stone pattern 620 and printed stone pattern 630. As shown, the first full-body stone pattern 610 is located on a front surface F, side surfaces S and a back surface B of the engineered stone 600, and the second full-body stone pattern 620 is located on a front surface F, side surfaces S and a back surface B of the engineered stone 600. In other words, the first full-body stone pattern 610 and the second full-body stone pattern 620 extend from the front surface F to the back surface B. As shown, the printed stone pattern 630 is located on the front surface F of the engineered stone 600. As mentioned above, the first full-body stone pattern 610 and the second full-body stone pattern 620 are formed according to the background pattern, and the printed stone pattern 630 is formed according to the vein pattern. In some embodiments, the first full-body stone pattern 610 and the second full-body stone pattern 620 have different colors.

Referring to Table 1 below for the durability test results of the engineered stone of the above embodiment. The durability test in Table 1 include using the above method to produce engineered stone printed with pure colors, for example, CMYK (cyan, magenta, yellow, black) engineered stone samples. The pure color engineered stone samples are placed in an ultraviolet (UV) tester for ASTM G154 testing to simulate the color changes over time outdoors of the pure color engineered stone sample. The durability test is more stringent than the environment in which engineered stone is normally used. The durability test includes a blank group and three experimental groups. The blank group is not placed in the UV tester, and the three experimental groups are placed in the UV tester for 24 hours (hr), 48 hr and 72 hr respectively. Table 1 shows the color difference (ΔE) measured between the chromaticity values of the three experimental groups and the blank group using a colorimeter. The larger the color difference, the greater the color change.

TABLE 1

| | C | M | Y | K |
|---|---|---|---|---|
| ΔE(24 hr) | 0.38 | 0.26 | 0.64 | 0.95 |
| ΔE(48 hr) | 1.22 | 0.96 | 1.4 | 2.09 |
| ΔE(72 hr) | 1.98 | 2.16 | 2.78 | 3.17 |

As shown in Table 1, the engineered stone produced by the method disclosed in the present disclosure has good durability, and the printed stone pattern on the engineered stone in present disclosure is not easy to change color or fade.

The engineered stone manufacturing method in the present disclosure can produce exquisite and realistic engineered stone. By setting reference points in the background pattern, vein pattern, and stone mold, the vein pattern to be printed can be accurately positioned during the transfer process. Moreover, the weather-resistant ink of the present disclosure contains a wetting and dispersing agent, the weather-resistant ink can stably combine the dye with the engineered stone and prevent it from discoloration or fading. The engineered stone produce by the method of the present disclosure has a full-body stone pattern extending from the front surface to the back surface, which can reduce the labor cost of treatment the side surface in the subsequent process.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An engineered stone, comprising:
a first full-body stone pattern comprising a first stone formulation;
a second full-body stone pattern comprising a second stone formulation, and the second stone formulation is different from the first stone formulation, wherein the first full-body stone pattern and the second full-body stone pattern are located on a front surface, a plurality of side surfaces and a back surface opposite to the front surface of the engineered stone;
a third full-body stone pattern comprising a third stone formulation, and the third stone formulation is different from the first stone formulation and the second stone formulation, wherein the third full-body stone pattern located on the front surface of the engineered stone and does not extend completely from the front surface to the back surface; and
a printed stone pattern located on the front surface of the engineered stone, and the printed stone pattern is overlapped with the first full-body stone pattern, the second full-body stone pattern, and the third full-body stone pattern.

2. The engineered stone of claim 1, wherein the first stone formulation, the second stone formulation, and the third stone formulation comprise:
recycling material, aluminum hydroxide, quartz powder, resin and pigment.

3. The engineered stone of claim 2, wherein the recycling material comprises:
recycled building material, recycled photovoltaic material, recycled glass, and combinations thereof.

4. The engineered stone of claim 1, wherein a first color of the first full-body stone pattern is different from a second color of the second full-body stone pattern.

5. The engineered stone of claim 4, wherein a third color of the third full-body stone pattern is different from the first color of the first full-body stone pattern and the second color of the second full-body stone pattern.

6. The engineered stone of claim 1, wherein the first full-body stone pattern extends from the front surface to the back surface of the engineered stone.

7. The engineered stone of claim 1, wherein the second full-body stone pattern extends from the front surface to the back surface of the engineered stone.

8. The engineered stone of claim 1, wherein a penetration depth of the printed stone pattern on the front surface of the engineered stone is 1 to 5 millimeter (mm).

9. The engineered stone of claim 1, wherein a thickness of the engineered stone is between 15 mm to 30 mm.

10. The engineered stone of claim 1, wherein the third full-body stone pattern is located on the front surface and one of the plurality of side surfaces of the engineered stone.
